(19) United States
(12) Patent Application Publication
(10) Pub. No.: US 2011/0108593 A1
(43) Pub. Date: May 12, 2011

(54) Beverage Carrier Stability and Retention System and Method

(76) Inventors: Brent Caldwell, Ferndale, WA (US); Chris Pomeroy, Ferndale, WA (US)

(21) Appl. No.: 12/939,055

(22) Filed: Nov. 3, 2010

Related U.S. Application Data
(60) Provisional application No. 61/259,092, filed on Nov. 6, 2009.

(51) Int. Cl. B60R 11/00

(52) U.S. Cl. 224/545

(57) ABSTRACT

A portable beverage container retention stabilization system (PBCRSS) for use in a vehicle is provided. The PBCRSS as a vehicle retainer which interoperates with a flexible base member at a retainer base support. The flexible base member is flexible along a longitudinal plane. The flexible base member can temporarily anchor the PBCRSS at one or more locations within the vehicle. The vessel retainer has a cylindrical sidewall with an open top. A beverage container can be inserted into the vessel retainer through the open top or side all. The vessel retainer will hold the beverage container in an upright position and resist overturning moment in combination with the flexible base member. The flexible base number has a first anchor system and a second anchor system to anchor the PBCRSS at a temporary stable location. The PBCRSS can be moved from one stable location to another in the vehicle and hold the beverage container in an upright position.

### RELATED APPLICATIONS

This application claims priority benefit of U.S. Ser. No. 61/259,092 filed Nov. 6, 2009.

### BACKGROUND

U.S. Pat. No. 4,955,516 discloses a portable beverage carrier which is adapted to mount on a horizontal top frame tube of a bicycle and includes a pair of insulated receptacles. In the summary of the invention section in column 2 around line 17 “a portable beverage carrier, adapted for mounting on a horizontal top frame tube of a bicycle, which includes a pair of insulated receptacles, each dimensioned to receive one or a plurality of standard beverage containers. The insulated receptacles each include a zipper fastened cover. The covers and receptacles are each formed from a fabric material lined with a gel refrigerant encapsulated with a waterproof liner. An elongated strap has opposite ends secured to each of the receptacles and first cooperating hook and loop fasteners are provided for securing the strap to a bike top frame tube.”

US patent application number 2004/0113446 discloses a spill-proof carrier for open topped beverage containers where the carrier has one or more rigid support members having upper and lower end portions, which are connected transversely to a generally peripheral portion of the one or more carrier members. The upper end portion bows substantially over the axis of gravitational acceleration of the one or more carrier members. As can be seen in the detailed description on page 2 paragraph 28 “carrying open top beverage containers while walking, especially on a stairway or over uneven terrain, often causes spillage of the beverage to a greater or lesser extent. The spillage is generally occasioned by the uneven gate of the carrier, stumbling, or obstructions in the path of the carrier.”

US patent application number 2004/0140411 to inventor Roe, discloses a portable beverage holder apparatus which includes a clamping means, a hanger member, a clamp to hanger hinge means, connected between the clamping means and the hanger member, a cup and hanger to cup hinge connected between the hanger member and the cup unit.

U.S. Pat. No. 4,846,429 to Scheurer discloses a releasable suction cup assembly as can be seen in the summary of the invention section in column 2 around line 8 “the invention relates to suction cup assemblies having an improved low cost vacuum release structure that is simple to operate in dissipating the vacuum grip between the cup and its attached surface.” As can be seen in column 3 around line 40 “the base of suction cup assembly is secured to a portable insulated beverage cup holder formed of a soft frangible thermally insulating composition in which a beverage can is deposed.”

U.S. Pat. No. 6,053,317 to Morris, discloses a bottle carrier which is portable and for transporting necked bottles includes a tubular housing with an open end configured to receive a bottle, a lid configured to fit over the open end of the tubular housing, and a neck protector disposed within the tubular housing and defining an opening for receiving the neck of the bottle. The tubular housing is made of one or more sheets of highly dense closed cell sponge material formed into a hollow cylinder with opposed longitudinal edges and has adjustable fasteners such as a zipper for joining the longitudinal edges of the housing together.

U.S. Pat. No. 2,893,675 to Smith et al, discloses a beverage holder for retaining glasses, bottles and cups in an upright position against the tendency of the receptacles to become tilted or upset. The beverage holder has been devised as can be seen in column 1 around line 19, to “be especially useful for the purpose of retaining receptacles upright on bodies, such as boats, planes, trains, automotive vehicles etc. while in motion.”

U.S. Pat. No. 5,325,991 to Williams, discloses an adjustable multipurpose drink holder with detachable insulator blanket for holding and supporting receptacles such as drinking cups, cans, bottles, and mugs comprising a flexible resilient blanket which has insulation qualities and can be wrapped around various diameter cylindrical open-ended chambers adapted to releasably hold the receptacle and then narrow elongated vertical support adapted to be bendable by hand into an L-shaped configuration to support the blanket at various heights relative to the L-shaped configuration.

U.S. Pat. No. 5,813,579 to Hendrickson, discloses a dual beverage holder which is adapted to be mounted around a console or gearshift. Each container holder has a substantially L-shaped base member having a horizontal bottom support and a back support vertically depending therefrom. Curved arms extend from opposing sides of the back support to receive and stabilize a beverage container.

U.S. Pat. No. 4,979,657 to Espiritu discloses a portable beverage container for an automotive vehicle and is formed of a single sheet of flat stiffened material such as cardboard, formed with creases to create a rectangular floor, a front, a back and sides. A pair of arms extend laterally from the front and back and are adaptable for insertion into slots in the sides.

U.S. Pat. No. 5,190,376 to Book, discloses an improved portable cooler that is collapsible, portable, and has a multiple use insulated bag with a companion detachable multiple use bag for use in transporting and storing items commonly used while driving an automobile. The bag may be used to carry cassettes which are then insulated from outside heat as well as beverage containers such as aluminum cans that are maintained at a cooler temperature. The bag is especially convenient for placing on the center console of automobiles that have such space on the floor.

U.S. Pat. No. 6,318,689 to Rodriguez discloses a container holder for removably securing to a mounting surface. The present invention as seen in column 1 around line 10 “generally relates to the field of beverage vessel holding devices for securing to support structures, was common only within vehicles such as boats.” Referring to the summary of the invention section in column 4 around line 8 “a container holder is provided for securing to a mounting surface and for receiving and retaining a container, including an elongated lash member having a first lash member and a second lash member end; a first lash member attachment mechanism secured to the first lash member end; the second lash member attachment mechanism secured to second lash member end; and a container receiving pouch structure suspended substantially vertically from the horizontal elastic retaining lash.”

U.S. Pat. No. 5,282,598 to Greene discloses a container holder which may be used to hold or support a beverage container in an automobile by inserting an elongated member with a securing portion between the back rest and seat cushion of a seat, or between the backrests of two adjacent seats. The elongated member of the securing portion may be releasably or permanently attached to a receptacle portion used to hold the beverage container.

U.S. Pat. No. 6,571,976 to Sonnabend discloses an insulated container sleeve with suction base which includes an enclosed wall and a flexible concave base defining an orifice. The flexible concave base connects to the cylindrical wall with the orifice within the enclosed wall. The flexible concave base opens away from the enclosed wall. The sleeve insulates the container, holds the container, attaches the container to a surface, and encases the removal of the container from the sleeve.

U.S. Pat. No. 5,447,764 discloses an insulated retainer for a beverage container where the retainer is a cylindrical sleeve with an open top and an open bottom. The bottom has a flexible base which provides stability to the beverage container. As can be seen in column 2 around line 40 “the base is generally tubular with a flat top surface and a flat bottom surface joined to a base parameter. The top surface joins an outer sidewall in a generally perpendicular relation. The base is a flexible resilient material capable of maintaining the stability of the beverage container on an uneven surface such as automobile seat, . . . , floor, or the like. Materials for the base might include nitrile or uni-cellular foam. The base should have a nonskid surface at the bottom surface . . . the base may be attached to the sleeve by glue or other adhesives.”

U.S. Pat. No. 2,640,595 to Byford discloses an automobile seat article holder whereas can be seen in column 1 around line 36 “the invention has to do with a sheet material mat-like base which may be laid flat upon the crown of the usual seat cushion in which includes a retaining flap, the flap is hingeably mounted and adapted to be wedged between the cushion and the back rest of the seat structure in a manner to frictionally and satisfactorily locate and retain the mat in order for the receptacles or holders to be used.”

### BRIEF DESCRIPTION OF THE DRAWINGS

FIG. 1 is a side elevational view of the portable beverage container retention and stabilization system (PBCRSS);

FIG. 2 is a top plan view of the PBCRSS;

FIG. 3 is a side elevational overview of an alternative embodiment of the PBCRSS;

FIG. 4 is a bottom plan view of an alternative embodiment of the PBCRSS;

FIG. 5 is a sectional elevational view of the PBCRSS on a boat gunnel wall;

FIG. 6 is a top plan view of an alternative embodiment of the PBCRSS;

FIG. 7 is a top plan view of an alternative embodiment of the PBCRSS;

FIG. 8 is a side elevational overview of the Velcro anchor system;

FIG. 9 is a side elevational overview of the section cup anchor system;

FIG. 10 is a side elevational view of the weight anchor system;

FIG. 11 is a side elevational view of the magnet anchor system;

FIG. 12 is a schematic flow chart of the method of using a PBCRSS.

### DESCRIPTION OF THE PREFERRED EMBODIMENTS

Generally speaking what is provided is a portable, nonskid grip beverage container retention and stability system which holds beverages similar to a couise where the beverage carrier itself provides stability and retains the beverage in an upright position during travel in a moving vehicle.

For example, a recreational vehicle such as an RV, boat, car, mobile home, etc., will encounter varying terrain which provides for jostling within the vehicle. The passengers in the vehicle may have beverages in open containers such as a soda can. A system is provided for holding the open container/beverage when the passenger is not holding the beverage itself, so that the beverage maintains an upright position and does not spill when the jostling occurs due to the movement of the vehicle over the rough terrain.

Also, the passengers may wish to move their beverage if they move from seat to seat in the RV or in the boat. Thus the boat or RV cup holders which are built into the upholstery/seats of the vehicle cannot move with the passengers when they change positions. Therefore, the beverage carrier must be able to move and be portable from one location to another and create a stable footing for support of the beverage that the beverage carrier is holding.

Because of the varying surface support locations within the vehicle itself, for example a boat will have a gunnel wall which surrounds the boat and provides a top surface of the gunnel wall as a potential resting place for a beverage, various surfaces such as tabletops, arm chair arms, seats, and flat surfaces of the boat hull or the, for example, dashboard on the vehicle. All of these surfaces have varying surface characteristics which must be accommodated when the beverage carrier is placed on the surface.

In order to provide a malleable or adjustable beverage carrier foundation, the beverage carrier may have a base footing which is weighted and is configurable to the surface it is resting on. The base footing may have anchors which are either deadweight anchors, frictional anchors such as Velcro or nonskid material, or suction cups for attaching to smooth suctionable surfaces within the vehicle.

The beverage carrier also includes a beverage enclosure for holding the beverage container in an upright position. The beverage enclosure is generally a cylindrical wall with an opening at the top, sometimes shaped like a bottle, or configured to maintain a soda can, beer can, or other standard sized beverage container in an upright position. The beverage enclosure may have insulating properties such as being constructed of a foam material or rubberized material. The beverage enclosure may also be made of a neoprene material. The beverage container or beverage enclosure may be fixed permanently to the base footing or it may be removed from the base footing through a series of connections such as Velcro, mechanical connections, magnetic connections, etc.

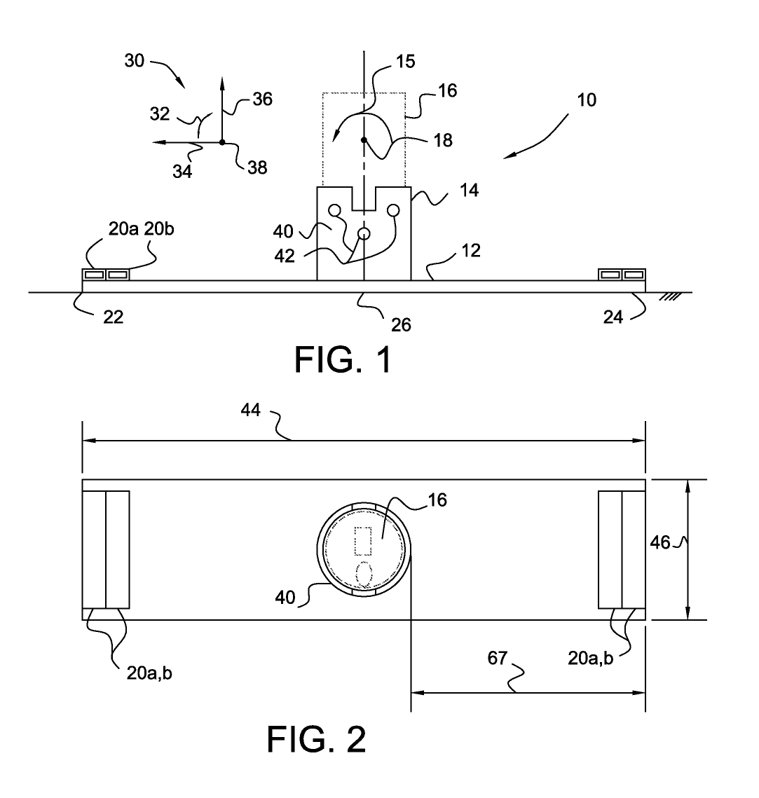

Therefore the portable beverage container retention and stabilization system 10 as seen in FIG. 1 includes the following components and embodiments in present and alternative forms, as seen throughout the drawings.

Referring to FIG. 1, the portable beverage container retention and stabilization system 10 includes a flexible base 12 which is malleable in some embodiments and may be made of neoprene material, rubber, or other flexible material. It may also be a composite material as may be desired for proper support of the vessel retainer 14. The vessel retainer 14 in this particular embodiment is of a cylindrical sidewall construction 40 which includes various slots in air ports 42 and a finger slot for removal of the beverage container 16. The beverage container may be a 12 or 16 ounce can or bottle or other standard size beverage containing structure as found in the market. The container retention and stabilization system 10 is arranged about an axis 30 which includes a longitudinal plane 32 defined by a longitudinal axis 34 and a vertical axis 36 as well as a transverse axis 38. The cylindrical wall 40 of the vessel retainer 14 may be constructed of foam, rubber, neoprene, or other type of material similar or non-similar to the flexible base material 12. For example, the vessel retainer 14 may also be constructed of plastic, metal, an alloy, etc. Furthermore, the malleable/flexible base 12 is constructed to be primarily flexible within the longitudinal plane 32. Therefore, while a neoprene structure may be used, a linked system with rigidity in the transverse direction but flexibility in the longitudinal plane or longitudinal axis may be provided for seating of the movable base on various non-uniform surfaces 18.

The malleable base or movable base 12 has a first longitudinal end 22 and a second longitudinal end 24. The first and second ends are each provided with an anchor system 20 which in this particular embodiment includes a dead weight anchor 20A and 20B at each of the longitudinal ends of the base.

The present embodiment provides a base which is a rectilinear form as seen in FIG. 2, where the length of the base ranges from between 12 to 24 inches in length, and the width of the base 46 ranges in distance from 3″ to 6″. While a rectilinear form is provided, other forms such as oval, non linear, and trapezoidal, are readily envisioned. The anchor systems 20 along with the longitudinally flexible base 12 provide for anchoring of the vessel retainer 14 at the retainer-based support location 26 and resist overturning moments 15 due to the jostling of the vehicle within which the beverage container 16 is riding. For example, the waves that a boat is traveling on may provide for change in position of the center of gravity 68 of the beverage container 16. If the center of gravity 68 of the beverage container 16 falls over the outside edge of the footing toe 69, the beverage container 16 would tilt over and spill. By providing a larger base 12, the tipping of the beverage container 16 is effectively contained because of the increased toe footing distance 67 in resisting overturning of the beverage container 16. In addition, by providing the anchor system 20 along with the frictional resistance 110 as seen in FIG. 9, of the base 12, the base itself stays relatively 100% stationary within the moving vehicle while still allowing for portability.

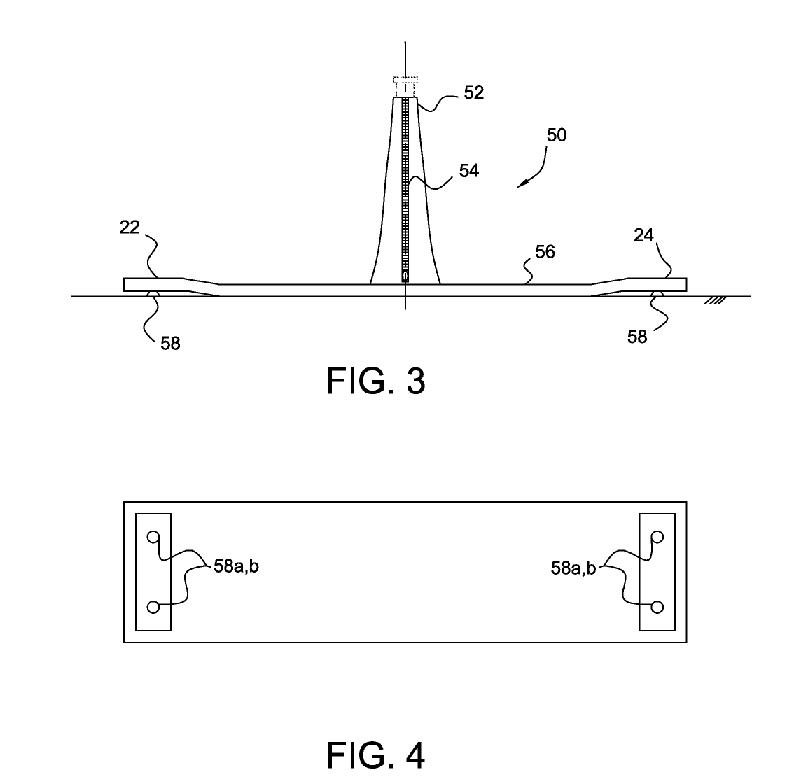

In an alternative embodiment as referring to FIGS. 3 and 4, and the portable beverage container retention and stabilization system 10 is shown in a bottle embodiment 50 where a neoprene sidewall enclosure 52 is fixedly attached to the base 56 and a zipper enclosure 54 is provided for opening/closing the sidewall enclosure 52 of the vessel retainer 14. The anchor system at each of the first longitudinal end 22 and second longitudinal end 24 has a suction cup anchor system 58. The suction cup anchor system is operably detachable to and from the smooth surface 18 of the vehicle. In this particular embodiment, there are two transversely aligned suction cups 58A and 58B in each of the longitudinal ends.

While the vessel retainer 14 as seen in FIGS. 1 and 3 is shown in a connected state, the vessels may be operably detachable from the base 12 at the retainer-based support location 26 by having connection mechanisms attached to the base of the vessel retainer 14. These connection mechanisms may include magnets, Velcro connections, or mechanical sleeve connections. These mechanical sleeve connections may also include a mechanical zipper connection.

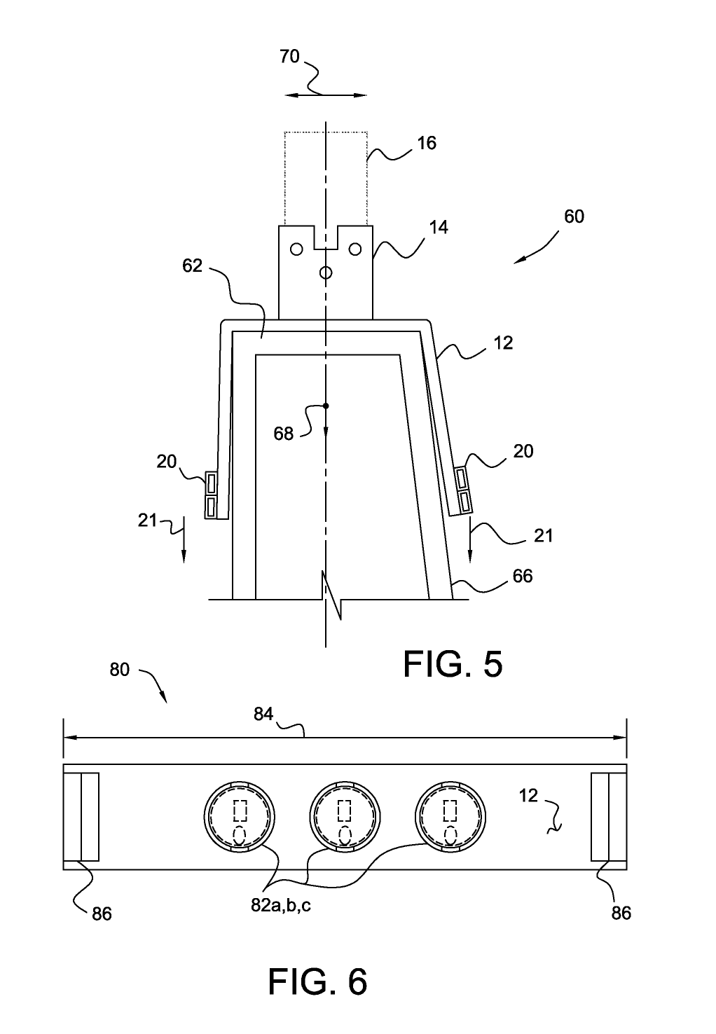

Referring to FIG. 5, a boat gunnel sidewall embodiment 60 is provided where the portable beverage container retention and stabilization system 10 is arranged on and over the boat gunnel wall. While the present embodiment is shown over a boat gunnel wall, the same embodiment would be position-able over a console in a automotive vehicle or truck. The boat gunnel includes a gunnel top wall 62, a gunnel outer wall 64, and a gunnel inner wall 66. The gunnel top wall 62 may vary in widths between 3″ and 12″ or greater depending upon the particular boat design, but the top wall 62 is generally wide enough to seat at least the retainer-based support distance 26 as seen in FIG. 1. Accordingly in one embodiment, the base 12 is sized to support the beverage container and drape over the gunnel wall to provide effective anchoring.

By providing a “draping” effect over the gunnel wall, the anchors 20 create a lower center of gravity position and anchor the movable flexible base 12 over the gunnel wall itself. Because the center of gravity 68 is at such a low position, along with the frictional resistance between the surface of the gunnel wall and the bottom surface of the flexible base, the system will maintain the beverage container 16 in an upright position within the vessel retainer 14 during the longitudinal or transverse overturning movement 70 experienced in the boat.

In an alternative embodiment, referring to FIG. 6 a multiple longitudinally aligned beverage containing embodiment 80 is provided where the base 12 of the overall system is elongated to accommodate a first vessel retainer 82A a second vessel retainer 82B and a third vessel retainer 82C at the midpoint of the base portion 12. Additional anchors 86 are provided at each of the longitudinal ends to maintain the footing position.

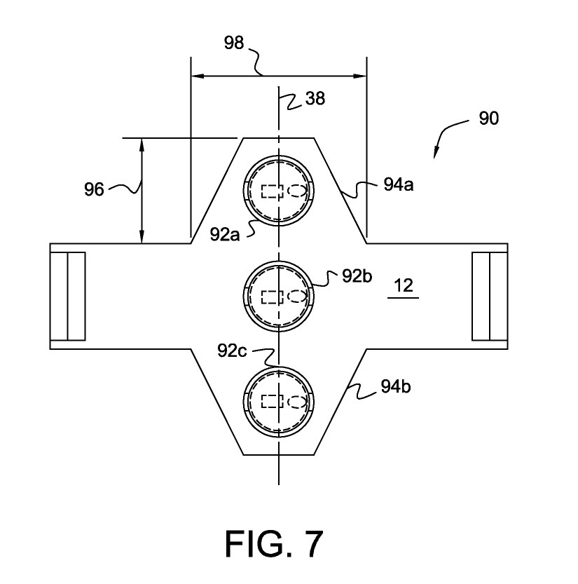

In a second alternative embodiment, a multiple transversely aligned beverage containing embodiment 90 is provided as seen in FIG. 7 where the vessel retainers are arranged along a transverse axis 30 instead of the longitudinal axis as seen in FIG. 6, and the base portion 12 is adjusted to encompass the additional width through the inclusion of transversely aligned wings 94A and 94B. The transversely aligned wings have a wing width 98 and a wing length 96 which enables the base to at least encompass the retainer base support location of the vessel retainers 92A and 92C where the central vessel container 92B is positioned within the longitudinal portion of the base section 12.

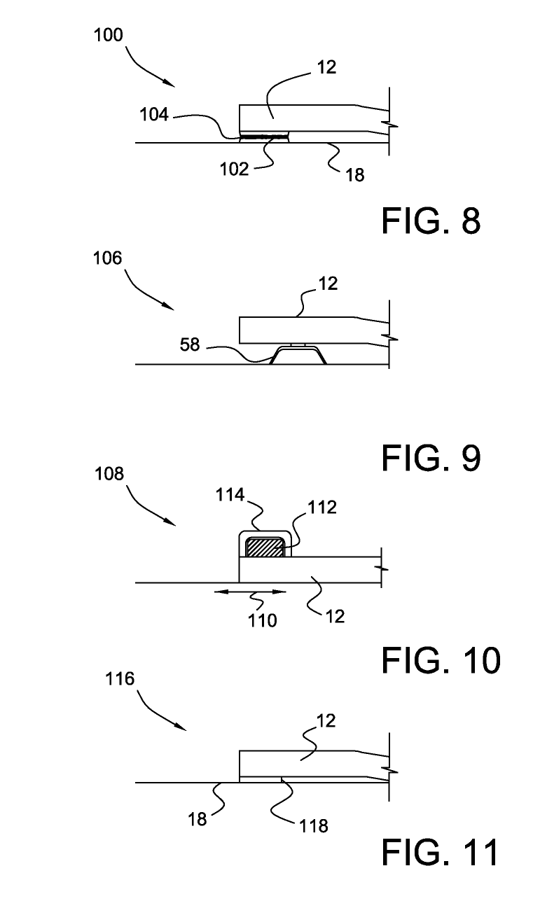

Now referring to FIGS. 8 through 11, a brief discussion of the various types of anchor systems will now be provided. In FIG. 8, a Velcro type anchor system 100 is provided where the flexible base 12 has at each longitudinal end a Velcro connection system where a first hook and loop fastener 102 is connected to the surface 18 of the vehicle, and a second hook and loop fastener 104 is connected to the base 12. In this particular embodiment, predetermined seating locations for the base 12 would have to be provided throughout the vehicle because of the semi-permanent nature of the first hook and loop fastener 102 connected to the surface of the vehicle 18.

Referring to FIG. 9, a suction cup anchor system 106 is discussed where as previously indicated, the suction cup 58 is attached to the end of the base 12 and when pressure is applied downwards onto the suction cup, the base 12 is mechanically pressurized and connected to the surface 18 of the vehicle.

Referring to FIG. 10, a weight anchor system 108 is provided where the dead weight 112 can be inserted or removed from the base 12 by insertion into a sleeve 114 which is built onto the base 12. While this particular embodiment has a dead weight anchor system with for example metal bars, other embodiments may include filled pouches of sand or aggregate which for the longitudinal length of the base providing additional deadweight of the system for anchoring.

In addition, and for all of the anchor systems, a surface area frictional resistance 110 is provided between the surface 18 and the bottom surface of the base 12. With a rubberized base material 12, a large frictional resistance force can be utilized to resist sliding of the overall system.

Referring to FIG. 11, a magnet anchor system 116 is provided where the magnet 118 is connected to the base 12 and is magnetically attracted to the metal surface 18 of the vehicle.

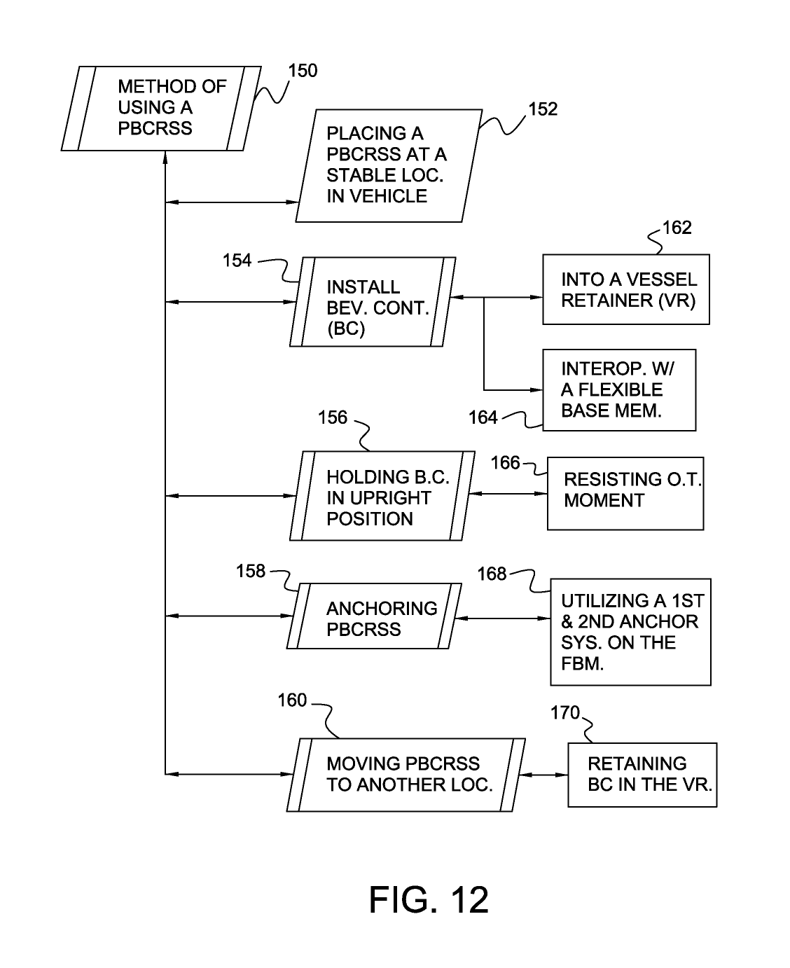

Referring now to FIG. 12, a brief discussion of the method of using the portable beverage container retention stabilization system (PBCRSS) 150 will now be provided. Generally speaking when a user enters into a vehicle such as a boat or a car, they will place the PBCRSS at a stable location in the vehicle at step 152. For example, they may place it on the dashboard, on the gunwale of the boat, or other surface such as a seat or floor of the vehicle. If the beverage is not already installed into the PBCRSS, the user can choose to do so by installing the beverage container at step 154 into the vessel retainer at step 162 of the PBCRSS. The vessel retainer is interoperability attached to the flexible base member at step 164. In other words, the vessel retainer in one embodiment may be permanently affixed to the flexible based member, and in another embodiment, the vessel retainer may have an interoperable attachment means to physically attach to the flexible based member.

Once the beverage container is installed into the vessel retainer, the PBCRSS will be holding the beverage container in an upright position at step 156. The PBCRSS can then resist overturning moments at step 166 by utilizing the strengthened combination of the vessel retainer in combination with the flexible base member.

As discussed above, the PBCRSS can be anchored at a stable location in the vehicle at step 158 by utilizing a first and second anchor system at step 168. The first and second anchor systems are arranged on the flexible based member and in one embodiment are placed at first and second end locations of the flexible base member. As discussed above, the anchors may be suction cups, dead weights, hook and loop type Velcro fasteners, or magnets. Furthermore, the flexible base member may utilize its frictional resistance along the bottom surface of the base member.

If desired, the user can move the PBCRSS to another location at step 160 and optionally retain the beverage container in the vessel retainer at step 170.

Therefore I claim:

1. A portable beverage container retention stabilization system for use in a vehicle, said system comprising:
a. a vessel retainer configured to interoperably attach to a flexible base member at a retainer base support;
b. said flexible base member configured to be flexible along a longitudinal plane defined by a longitudinal axis, a vertical axis, and a transverse axis;
said flexible base member further configured to temporarily anchor said container retention and stabilization system at a temporary location in the vehicle;
c. said vessel retainer further comprising a cylindrical sidewall having an open top and an insertion means for inserting and removing a beverage container from said vessel retainer; said vessel retainer further configured to maintain said beverage container in an upright position and resist an overturning moment when said vessel retainer is interoperably attached to said flexible base member;
d. said flexible base member further comprising a first end and a second end, said first end comprising a first anchor system, said second end comprising a second anchor system;
e. whereby, said portable beverage container retention and stabilization system can be moved from one stable location to another in said vehicle and hold said beverage container in an upright position.

2. The system according to claim 1 wherein said flexible base member further comprises: a material comprising foam.

3. The system according to claim 1 wherein said flexible base member further comprises: a material comprising rubber.

4. The system according to claim 1 in said flexible base member further comprises: a material comprising neoprene.

5. The system according to claim 1 wherein said flexible base member further comprises: a linked system with rigidity along said transverse axis.

6. The system according to the claim 1 wherein said flexible base member further comprises: a base length between said first end and said second end, and a base width.

7. The system according to the claim 6 wherein said flexible base member further comprises: said base length comprising a distance of at most 24 inches.

8. The system according to claim 6 wherein said flexible base member further comprises: said base length comprising a distance of at least 12 inches.

9. The system according to the claim 6 wherein said flexible base member further comprises: said base width comprising a distance ranging between 3 inches and 6 inches in length.

10. The system according to the claim 1 wherein said vessel retainer further comprises: a material comprising foam.

11. The system according to the claim 1 wherein said vessel retainer further comprises: a material comprising rubber.

12. The system according to claim 1 wherein said vessel retainer further comprises: a material comprising neoprene.

13. The system according to claim 1 wherein said vessel retainer further comprises: a vertically aligned zipper enclosure installed vertically on said cylindrical sidewall.

14. The system according to claim 1 wherein said vessel retainer further comprises: a plurality of ports for providing beverage container removal.

15. The system according to claim 1 wherein said vessel retainer further comprises: said beverage container comprising a 12 ounce beverage; a 16 ounce beverage.

16. The system according to the claim 1 wherein said flexible base member further comprises: said first anchor system and said second anchor system each comprising a Velcro anchor system wherein a hook or loop type fastener is installed onto said first and second anchor system and a hook or loop type fastener is installed onto an anchor location on said vehicle surface opposite each of said first anchor system and said second anchor system.

17. The system according to the claim 1 wherein said flexible base member further comprises: said first anchor system and said second anchor system each comprising: a suction cup anchor system arranged at each of said first and second anchor systems to anchor said flexible base member to a location in vehicle.

18. The system according to claim 1 wherein said flexible base member further comprises: said first anchor system and said second anchor system each comprising: a weight anchor system sleeve for carrying a dead weight to anchor said flexible base member to a location within said vehicle.

19. The system according to the claim 1 wherein said flexible base member further comprises: said first anchor system and said second anchor system each comprising: a magnet for magnetically securing said flexible base member to a metallic surface within said vehicle.

20. A method of utilizing a portable beverage container retention stabilization system, said method comprising:
a. placing said portable beverage container retention stabilization system (PBCRSS) at a stable location within a vehicle;
b. installing a beverage container into a vessel retainer of said PBCRSS; said vessel retainer further comprising a cylindrical sidewall having an open top and an insertion needs for inserting and removing said beverage container from said vessel retainer, said vessel retainer or operating with a flexible base member;
a. holding said beverage container in an upright position by resisting an overturning moment experienced by said vehicle by utilizing said flexible base member of said PBCRSS in combination with said vessel retainer, said flexible base member configured to be flexible along a longitudinal plane defined by an longitudinal axis, a vertical axis, and transverse axis;
b. anchoring said PBCRSS by utilizing a first anchor system and a second anchor system each arranged at a first end and a second end respectively of said flexible base member;
c. moving said PBCRSS to another location in said vehicle while still retaining said beverage container in said vessel retainer.
